(19) United States
(12) Patent Application Publication
(10) Pub. No.: US 2012/0094617 A1
(43) Pub. Date: Apr. 19, 2012

(54) MODULE FOR MOBILE COMMUNICATION TERMINAL, AND MOBILE COMMUNICATION TERMINAL

(76) Inventors: Masazumi Tone, Ebina (JP); Akio Yamamoto, Hiratsuka (JP); Takashi Shiba, Yokosuka (JP); Osamu Hikino, Yokohama (JP)

(21) Appl. No.: 13/221,937

(22) Filed: Aug. 31, 2011

(30) Foreign Application Priority Data
Oct. 18, 2010 (JP) 2010-233607

(51) Int. Cl. H04B 1/44

(52) U.S. Cl. 455/78

(57) ABSTRACT

A tunable filter in a tunable DPX module has frequency characteristics, and thus needs to be controlled with high accuracy so as to simultaneously cancel a transmission signal and noise in a reception band on a transmission side. For this reason, a canceller includes a filter having the same frequency characteristic as that of a tunable filter, and a structure having functions of compensating for an amplitude, a phase, and a delay. And, two lines of the cancellers are used to individually cancel a leak component of a transmission signal and a leak component of thermal noise in a reception band. In order to save the power consumption of the amplifier, a coupler is loosely coupled, and a combiner is tightly coupled. Further, in order to suppress the influence on a reception system due to the tough coupling, the combiner uses the amplifier for in-phase inputs.

### INCORPORATION BY REFERENCE

This application relates to and claims priority from Japanese Patent Application No. 2010-233607 filed on Oct. 18, 2010, the entire disclosure of which is incorporated herein by reference.

### BACKGROUND OF THE INVENTION

(1) Field of the Invention

The present invention relates to modules for mobile communication terminals, and mobile communication terminals. In particular, the invention relates to a module for a mobile communication terminal corresponding to a wireless communication system, for example, a wideband code division multiple access (WCDMA) system, a long term evolution (LTE) system, or the like, and to a mobile communication terminal including the same.

(2) Description of the Related Art

In addition to the WCDMA system put to practical use, the LTE system has been studied as applications to mobile phones. Each of the WCDMA system and the LTE system uses a transmission frequency band and a reception frequency band which are different from each other so as to perform transmission and reception at the same time. Thus, these systems employ a duplexer (DPX) filter for separation between the transmission and reception frequency bands.

In order to compensate for insufficient attenuation of frequency components outside the band of the DPX, a method for canceling thermal noise in a reception band is proposed as disclosed in “Adaptive Duplexer Implemented Using Single-Path and Multipath Feedforward Techniques With BST Phase Shifters: IEEE TRANSACTIONS ON MICROWAVE THEORY AND TECHNIQUES, VOL. 53, NO. 1, p. 106-114, JANUARY 2005” (described as “a non-patent document 1” bellow). A transmission signal is separated by use of a notch filter. And thermal noise in the reception band generated by a transmission circuit has its amplitude and phase adjusted, and then is combined with a transmission/reception signal and removed between the DPX and an antenna terminal. This cancels the thermal noise in the reception band, while suppressing the influence on the transmission signal.

In order to obtain good high-frequency characteristics, the WCDMA system and the LTE system use plural frequency bands, and include plural DPXs for the respective frequency bands in a front end module for a mobile phone. Further, the LTE system employs a multiple input multiple output (MIMO) technique for achieving a high-speed system, and thus needs as many reception circuits as antennas. Since an increase in scale of the reception circuit is anticipated in the future because of the increasing speed of the system, a technique for switching the DPX tunably is required as disclosed in Japanese Patent Application No. 2009-277142 (Laid-Open No. 2011-120120; described as “a patent document 1” bellow).

A patent document 1 discloses a tunable filter technique and a canceller technique for switching the DPX tunably. The canceller technique is to compensate for insufficient attenuation of signals outside the band of the tunable filter which has variable characteristics for permitting signals in plural frequency bands to selectively pass therethrough. The canceller cancels a leak component of a transmission signal included in a reception signal output from a tunable filter, and a leak component of thermal noise in a reception band.

### SUMMARY OF THE INVENTION

In order to compensate for the insufficient attenuation of signals outside the band of the tunable filter, the canceller disclosed in a patent document 1 needs to cancel each of the leak component of the transmission signal and the leak component of the thermal noise in the reception band by 20 dB or more. The tunable filter tends to lack about 20 dB of attenuation of signals outside the band of the filter from the viewpoint of design, as compared to the related art DPX. For example, the amount of attenuation of signals outside the band in the related art DPX is 50 dB, but the amount of attenuation in the tunable filter is decreased to about 30 dB. Thus, the above canceller needs to compensate for at least 20 dB of attenuation of signals outside the band. However, a single system including a coupler, an amplifier, a phase shifter, a delay unit, and a combiner as disclosed in a patent document 1 needs to perform control with high accuracy in order to cancel 20 dB or more of signals in a wide range from a frequency band of a transmission signal to a frequency band of a reception signal.

Each of the coupler on the input (transmission side) of the canceller and the combiner on the output (reception side) thereof needs to be loosely coupled so as to suppress the influence on the transmission and reception systems. In the canceller, the signal is attenuated because of the loose coupling, and thus it is necessary to increase a gain of an amplifier for amplifying the attenuated signal, which disadvantageously leads to an increase in power consumption.

Accordingly, it is an object of the present invention to ensure a predetermined amount of cancellation. Further, it is another object of one embodiment of the invention to reduce the power consumed by the amplifier.

In order to achieve the above objects, according to one aspect of the invention, a module for a mobile communication terminal having different respective frequency bands for a transmission RF signal to be transmitted and a reception RF signal to be received is characterized by the following features. The module includes an input/output unit for outputting the transmission RF signal to an antenna provided outside the module and for receiving input of the reception RF signal from the antenna provided outside the module. The module also includes a DPX filter comprised of a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit. The module further includes a first canceller adapted to allow a part of the transmission RF signal to branch from a preceding stage of the Tx filter of the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception signal. The module still further includes a second canceller adapted to allow another part of the transmission RF signal to branch from a preceding stage of the Tx filter of the DPX filter, to apply other predetermined signal processing to the branched signal, and then to combine the processed signal with the reception RF signal on a subsequent stage of the Rx filter of the DPX filter to thereby cancel a thermal noise component in the frequency band of the reception RF signal included in the reception RF signal.

According to another aspect of the invention, a module for a mobile communication terminal having different respective frequency bands for a transmission RF signal to be transmitted and a reception RF signal to be received is characterized by the following features. The mobile includes an input/output unit for outputting the transmission RF signal to an antenna provided outside the module, and for receiving input of the reception RF signal from the antenna provided outside the module. The mobile also includes a DPX filter comprised of a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit. The module further includes a canceller which is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception signal. Alternatively, the module further includes a canceller which is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal. The canceller includes a second Tx filter having substantially the same frequency characteristic as that of the Tx filter included in the DPX filter, and a second Rx filter having substantially the same frequency characteristic as that of the Rx filter included in the DPX filter.

According to still another aspect of the invention, a module for a mobile communication terminal having different respective frequency bands for a transmission RF signal to be transmitted and a reception RF signal to be received is characterized by the following features. The module includes an input/output unit for outputting the transmission RF signal to an antenna provided outside the module, and for receiving input of the reception RF signal from the antenna provided outside the module. The module also includes a DPX filter comprised of a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit. The module still further includes at least one of a first canceller and a second canceller. The first canceller is adapted to allow a part of the transmission RF signal to branch on a preceding stage of the Tx filter included in the DPX filter, to apply predetermined signal processing to the branched signal, and then to combine the processed signal with the transmission RF signal to thereby cancel a thermal noise component in the frequency band of the reception RF signal included in the transmission RF signal. The second canceller is adapted to allow a part of the reception RF signal to branch on a subsequent stage of the Rx filter included in the DPX filter, to apply other predetermined signal processing to the branched signal, and then to combine the processed signal with the reception RF signal to thereby cancel a leak component of the transmission RF signal included in the reception RF signal.

According to a further aspect of the invention, a mobile communication terminal having different respective frequency bands for a transmission RF signal to be transmitted and a reception RF signal to be received is characterized by the following features. A module for the mobile communication terminal included in the mobile communication terminal for transmitting the transmission RF signal and for receiving the reception RF signal includes an input/output unit for outputting the transmission RF signal to an antenna provided outside the module, and for receiving input of the reception RF signal from the antenna provided outside the module. The module also includes a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit. The module further includes a first canceller which is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception signal. The module still further includes a second canceller which is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal.

According to a still further aspect of the invention, a mobile communication terminal having different respective frequency bands for a transmission RF signal to be transmitted and a reception RF signal to be received is characterized by the following features. A module for the mobile communication terminal included in the mobile communication terminal for transmitting the transmission RF signal and for receiving the reception RF signal includes an input/output unit for outputting the transmission RF signal to an antenna provided outside the module, and for receiving input of the reception RF signal from the antenna provided outside the module. The module also includes a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit. The module further includes at least one of a first canceller and a second canceller. The first canceller is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception RF signal. The second canceller is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal. The canceller includes a second Tx filter having substantially the same frequency characteristic as that of the Tx filter included in the DPX filter, and a second Rx filter having substantially the same frequency characteristic as that of the Rx filter included in the DPX filter.

According to a still further aspect of the invention, a mobile communication terminal having different respective frequency bands for a transmission RF signal to be transmitted and a reception RF signal to be received is characterized by the following features. A module for the mobile communication terminal included in the mobile communication terminal for transmitting the transmission RF signal and for receiving the reception RF signal includes an input/output unit for outputting the transmission RF signal to an antenna provided outside the module, and for receiving input of the reception RF signal from the antenna provided outside the module. The module also includes a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit. The module further includes at least one of a first canceller and a second canceller. The first canceller is adapted to allow a part of the transmission RF signal to branch on a preceding stage of the Tx filter included in the DPX filter, to apply predetermined signal processing to the branched signal, and then to combine the processed signal with the transmission RF signal to thereby cancel a thermal noise component in the frequency band of the reception RF signal included in the transmission RF signal. The second canceller is adapted to allow a part of the reception RF signal to branch on a subsequent stage of the Rx filter included in the DPX filter, to apply other predetermined signal processing to the branched signal, and then to combine the processed signal with the reception RF signal to thereby cancel a leak component of the transmission RF signal included in the reception RF signal.

According to the aspects of the invention, the predetermined amount of cancellation can be ensured with high accuracy, and thus the performance of the module for a mobile communication terminal and the mobile communication terminal using the module can be improved.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an example of the configuration of a module for a mobile communication terminal according to a first embodiment;

FIG. 2 is a block diagram of a noise canceller and a Tx canceller in the first embodiment;

FIG. 3 is a frequency characteristic diagram showing a cancellation effect exhibited when the first embodiment is applied;

FIG. 4 is a circuit diagram showing an example of the configuration of a combiner used in the first embodiment;

FIG. 5 is a block diagram showing an example of the configuration of the mobile communication terminal in the first embodiment;

FIG. 6 is a block diagram showing an example of the configuration of a module for a mobile communication terminal according to a second embodiment; and

FIG. 7 is a block diagram showing an example of the configuration of a module for a mobile communication terminal according to a third embodiment.

### DETAILED DESCRIPTION OF THE EMBODIMENT

Now, the embodiments of the invention will be described below.

### First Embodiment

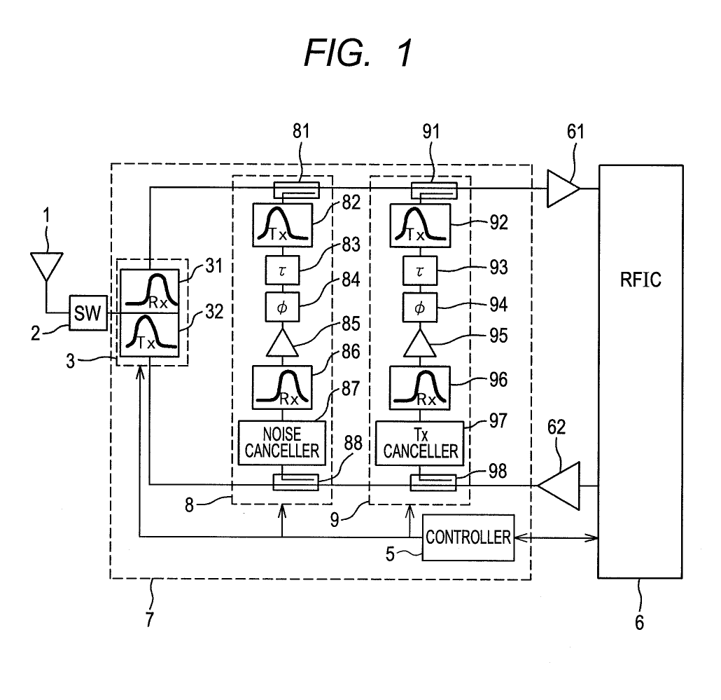

FIG. 1 shows a block diagram of an example of the configuration of a module for a mobile communication terminal according to a first embodiment. The structure of this embodiment is applied to, for example, a module for a mobile communication terminal of the WCDMA system or LTE system. However, the structure of this embodiment is not limited thereto, and can be applied to any other module for a mobile communication terminal which can perform the transmission and reception at the same time by assigning a transmission frequency and a reception frequency to different respective bands.

First, the flows of a transmission signal and a reception signal will be described below. A transmission signal (transmission RF signal) output from an RFIC 6 is input to a power amplifier (PA) 62, and amplified to a predetermined signal level. Then, the amplified signal passes through a coupler 98 in a canceller 9 and a coupler 88 in a canceller 8 to be input to a tunable filter 3. A Tx filter 32 in the tunable filter 3 suppresses signals other than the transmission signal, which passes with a low loss. The transmission signal output from the tunable filter 3 is radiated from an antenna 1 via an antenna 1 SW (switch) 2.

In contrast, a reception signal (reception RF signal) is input to the antenna 1, and passes through the antenna SW2 to be input to the tunable filter 3. An Rx filter 31 in the tunable filter 3 prevents the transmission signal from leaking therein, and permits the reception signal to pass therethrough with a low loss. The reception signal output from the tunable filter 3 is input to the RFIC 6 through a combiner 81 in the canceller 8, a combiner 91 in the canceller 9, and a low noise amplifier (LNA) 61.

Since a general DPX reduces the transmission signal by about 50 dB on the reception side, even when the antenna 1 receives a signal of “out of band blocking” in a level described in a non-patent document 1, the general system has little influence of degradation on the reception signal. When replacing the general DPX by a tunable DPX7, the tunable DPX7 of this embodiment is comprised of the tunable filter 3, the canceller 8, the canceller 9, and the controller 5.

Before starting the transmission and reception of the mobile communication terminal, calibration is performed so as to ensure a predetermined amount of cancellation in the module for the mobile communication terminal. In a single line of the canceller at that time, for example, even if the amount of cancellation of a leak component of transmission signal into a reception circuit becomes 20 dB or more, the amount of cancellation of a leak component of thermal noise in the reception band generated from the transmission circuit may be 20 dB or less, due to production variations of elements, a change in temperature, and the like.

For this reason, this embodiment includes two lines of cancellers 8 and 9. When the amount of attenuation by the tunable filter 3 is insufficient, for example that is 30 dB, by making the DPX tunable, the controller 5 controls to compensate an amplitude, a phase, and a delay in the following manner. That is, the canceller 8 cancels a leak amount of the transmission signal and the canceller 9 cancels a leak amount of thermal noise. In each case, the amount of cancellation is 20 dB or more to thereby set the amount of attenuation to 50 dB which is the same level as that of the general DPX. The compensation in this case, when canceling the transmission signal in the reception circuit, is a process for generating a signal, based on the transmission signal, of which amplitude is same and phase is inverted to those of the transmission signal passed through the tunable filter 3 from the transmission end to the reception end. Thus, the amplifier, a phase shifter, and the delay unit are disposed in the canceller. The amplifier includes a gain varying component, the phase shifter includes a phase varying component, and the delay unit includes a delay varying component.

The tunable filter 3 has a phase frequency characteristic and an amplitude frequency characteristic. In order for the tunable DPX 7 to obtain the amount of cancellation of 20 dB or more, the canceller 8 and the canceller 9 are desired to have an Rx filter and a Tx filter having the same frequency characteristics as those of the tunable filter 3. Thus, the canceller 8 for use includes the coupler 88, a noise canceller 87, an Rx filter 86, an amplifier 85, a phase shifter 84, a delay unit 83, a Tx filter 82, and the combiner 81. And, the canceller 9 for use includes the coupler 98, a Tx canceller 97, an Rx filter 96, an amplifier 95, a phase shifter 94, a delay unit 93, a Tx filter 92, and the combiner 91.

As described above, the first embodiment differs, for example, from a patent document 1 in that two lines of cancellers are provided. The tunable DPX7 individually includes the canceller 8 for canceling a leak component of the transmission signal and the canceller 9 for canceling a leak component of thermal noise. In order to obtain the predetermined amount of cancellation, each canceller includes the Rx filters 86 and 96 and the Tx filters 82 and 92 having the same frequency characteristics as those of the tunable filter 3. This arrangement can ensure the amounts of cancellation of the leak component of the transmission signal into the reception circuit, and of the leak component of the thermal noise with high accuracy.

In the following, the block structure and the flow of signals within the cancellers 8 and 9 will be described below.

The coupler 88 is loosely coupled to the transmission system, and draws the transmission signal attenuated by 10 dB or more and the thermal noise attenuated by 10 dB or more in the reception band, into the canceller 8. The noise canceller 87 cancels the thermal noise in the reception band by about 30 dB. In the subsequent Rx filter 86, the transmission signal is attenuated by about 30 dB. The amplifier 85 compensates for the amplitude, the phase shifter 84 compensates for the phase, and the delay unit 83 compensates for the delay. The Tx filter 82 attenuates the thermal noise in the reception band by about 30 dB, whereby thermal noise and harmonic distortion generated in the amplifier 85 are also attenuated. In the combiner 81, the transmission signal drawn into the canceller 8 and the thermal noise in the reception band are loosely coupled to be attenuated by 10 dB or more, and then combined with a leak component from the tunable filter 3 to be then cancelled. The level of thermal noise in the reception band output from the canceller 8 is very small, and thus the transmission signal is mainly cancelled.

On the other hand, the coupler 98 is loosely coupled to the transmission system in the same manner, and draws the transmission signal attenuated by 10 dB or more and the thermal noise in the reception band, into the canceller 9. The Tx canceller 97 cancels the transmission signal by about 30 dB. In the subsequent Rx filter 96, the transmission signal is attenuated by about 30 dB. The amplifier 95 compensates for the amplitude, the phase shifter 94 compensates for the phase, and the delay unit 93 compensates for the delay. The Tx filter 92 attenuates the thermal noise in the reception band by about 30 dB, whereby thermal noise and harmonic distortion generated in the amplifier 95 are also attenuated. In the combiner 91, the transmission signal drawn into the canceller 9 and the thermal noise in the reception band are loosely coupled to each other to be attenuated by 10 dB or more, and then combined with a leak component from the tunable filter 3 to be then cancelled. The level of the transmission signal output from the canceller 9 is small enough to mainly cancel the thermal noise in the reception band.

Referring to FIG. 1, the Rx filter 86(96) and the Tx filter 82(92) included in the canceller 8(9) are arranged in the reverse order with respect to the Rx filter 31 and Tx filter 32 included in the tunable filter 3. Even when the coupler 88(98) is loosely coupled to the transmission system and draws the transmission signal attenuated by about 10 dB, the power of the signal is a large power, for example, +0 to the order of 20 dBm. The amplitude of the signal is large as it is, which makes it difficult to perform signal processing after the amplifier 85(95). Thus, the Rx filter 86(96) whose attenuation is large with respect to the transmission signal is positioned on the preceding stage of, that is, before the amplifier 85(95), so that the transmission signal drawn is controlled to have an amplitude appropriate for the signal processing. Thus, the Rx filter and the Tx filter in the canceller 8(9) are arranged in the reverse order with respect to those in the tunable filter 3, whereby the Rx filter is located previous to the Tx filter.

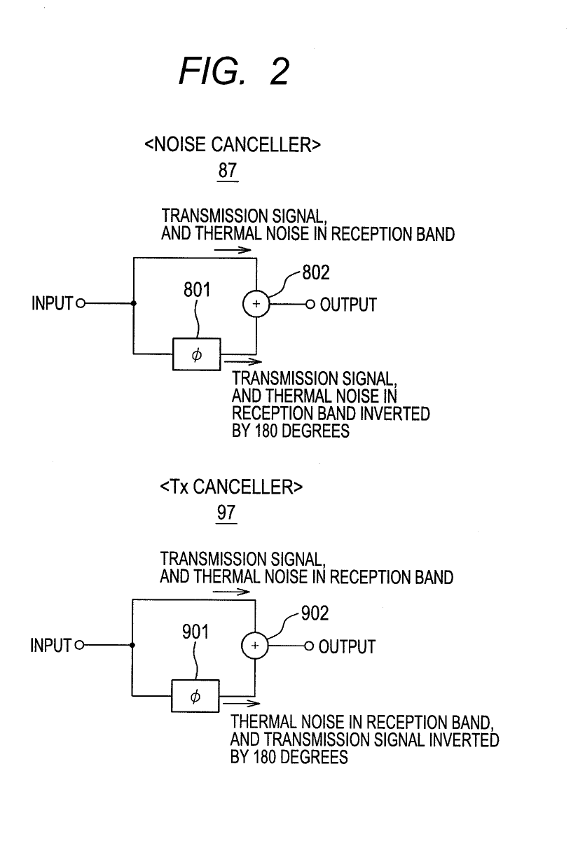

FIG. 2 shows a block diagram of the noise canceller 87 and the Tx canceller 97. The noise canceller 87 is comprised of a phase shifter 801 and a combiner 802. The thermal noise in the reception band output from the PA is inverted by 180 degrees at the phase shifter 801. In the combiner 802, the thermal noise in the reception band is cancelled and the transmission signal passes therethrough without phase inversion. The Tx canceller 97 is comprised of a phase shifter 901 and a combiner 902. The transmission signal output from the PA is inverted by 180 degrees at the phase shifter 901. In the combiner 902, the transmission signal is cancelled and the thermal noise in the reception band passes therethrough without phase inversion.

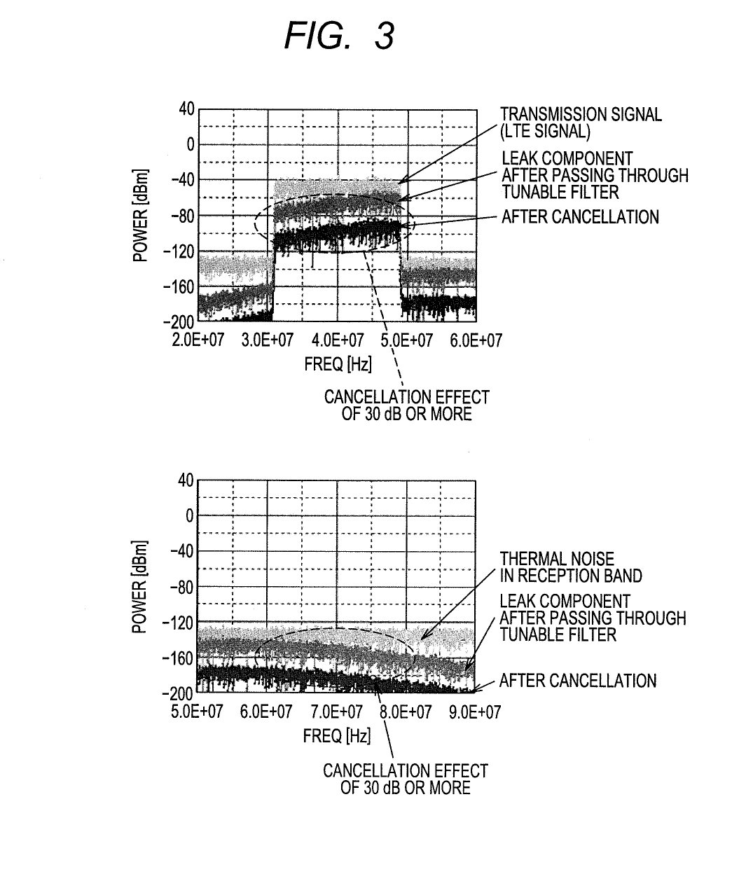

As shown in the diagram of the frequency characteristics in FIG. 3, the canceller 8 cancels the leak component of the transmission signal (LTE signal), and the canceller 9 cancels the leak component of thermal noise in the reception band. As a result, the cancellation effect produced by the controller 5 for compensating for the amplitude, phase, and delay becomes 30 dB or more, which sufficiently satisfies the above condition of 20 dB.

The canceller 8 includes the Rx filter 86 and the Tx filter 82 having the same frequency characteristics as those of the tunable filter 3. The canceller 8 can obtain the cancellation characteristic of the transmission signal with high accuracy by sufficiently satisfying the predetermined amount of cancellation of 20 dB by performing adjustment so as to make the amount of cancellation of the transmission signal maximum. Likewise, the canceller 9 can also obtain the cancellation characteristic of thermal noise with high accuracy.

The controller 5 has three main functions. The first function is selection among bands of the tunable filter 3, the canceller 8, and the canceller 9 so as to respond to the bands of the WCDMA system and the LTE system. The second function is compensation for the amplitude of the amplifier 85(95), the phase of the phase shifter 84(94), and the delay of the delay unit 83(93) according to an output level of the PA62. The third function is calibration for compensating for product variations of the tunable filter 3, the canceller 8, and the canceller 9, and for degradation of performance thereof due to the temperature.

The controller 5 shown in FIG. 1 is disposed in the tunable DPX7, and exchanges information necessary for the control with the RFIC6. However, the controller 5 may be included in the RFIC6.

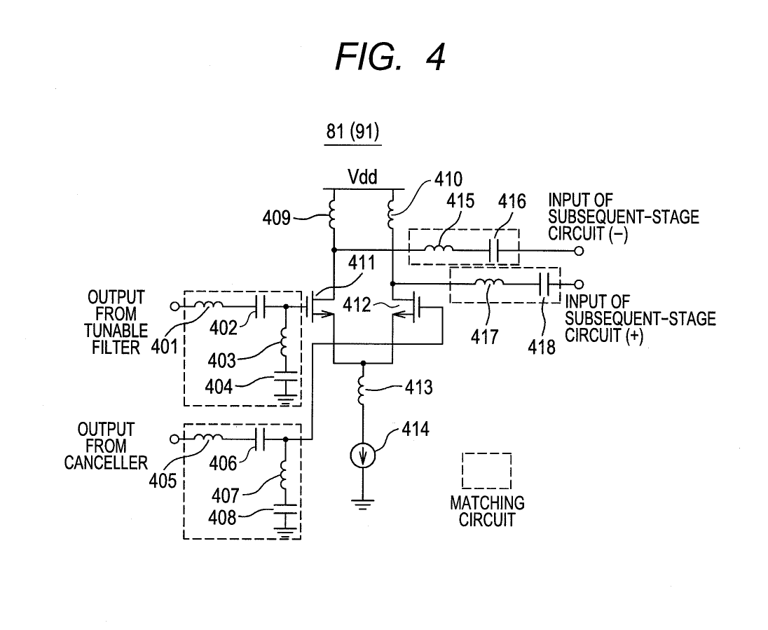

FIG. 4 shows an example of the configuration of a circuit of the combiner 81(91) when the combiner 81(91) is coupled not loosely but tightly so as to save power consumption of the amplifier 85(95). The combiner 81 and the combiner 91 may have the same configuration of the circuit. Now, the flow of a signal and the components of the combiner 81 will be described below.

The signal passing through the tunable filter 3 and the signal passing through the canceller 8 are input to a transistor 411 and a transistor 412, respectively, via a matching circuit comprised of elements 401 to 404, and a matching circuit comprised of elements 405 to 408. When the two signals are input in the same phase, the in-phase signals appearing at drains of the transistor 411 and transistor 412 are cancelled to each other by a constant current source 414. An inductor 409 and an inductor 410 serve as loads. An inductor 413 is disposed to suppress the distortion when a signal with a large amplitude is input thereto. When the predetermined amount of cancellation of 20 dB or more is obtained by a differential amplifier at a gate input of each of the transistor 411 and the transistor 412, a subsequent-stage circuit with a single input configuration may be connected via the matching circuit comprised of elements 417 and 418.

In contrast, when the predetermined amount of cancellation is not obtained by restriction of consumed current, the signals output from the drains of the transistor 412 and the transistor 411 are input to a positive electrode and a negative electrode of the subsequent-stage circuit with a differential input configuration, respectively, via the matching circuit comprised of elements 417 and 418 and the matching circuit comprised of elements 415 and 416. Thus, the predetermined amount of cancellation can be obtained by using the function of removing the in-phase signals at the subsequent-stage circuit.

In the above four matching circuits, the inductors and the capacitors are arranged as shown in FIG. 4, but such an arrangement is one example of the matching circuit configuration. The arrangement of elements is not limited thereto.

Conventionally, a combiner used in the canceller is comprised of passive elements including a coil and a capacitive element. This unit does not have any influence on a reception signal at an output of the tunable filter 3, and thus needs the loose coupling so as to provide the combiner. Thus, the combiner attenuates the signal, for example, by about 10 dB. In contrast, in this embodiment shown in FIG. 4, the combiner is comprised of active circuits. Even when the combiner 81 is tightly coupled, this embodiment has little influence on the reception signal, which can reduce the attenuation of the combiner 81, for example, to 0 dB. Thus, the amplifier 85 should amplify the attenuation caused due to the loose coupling of the coupler 88. That is, the amplifier 85 can reduce a gain by about 10 dB, as compared to the related art, which can save the power consumption.

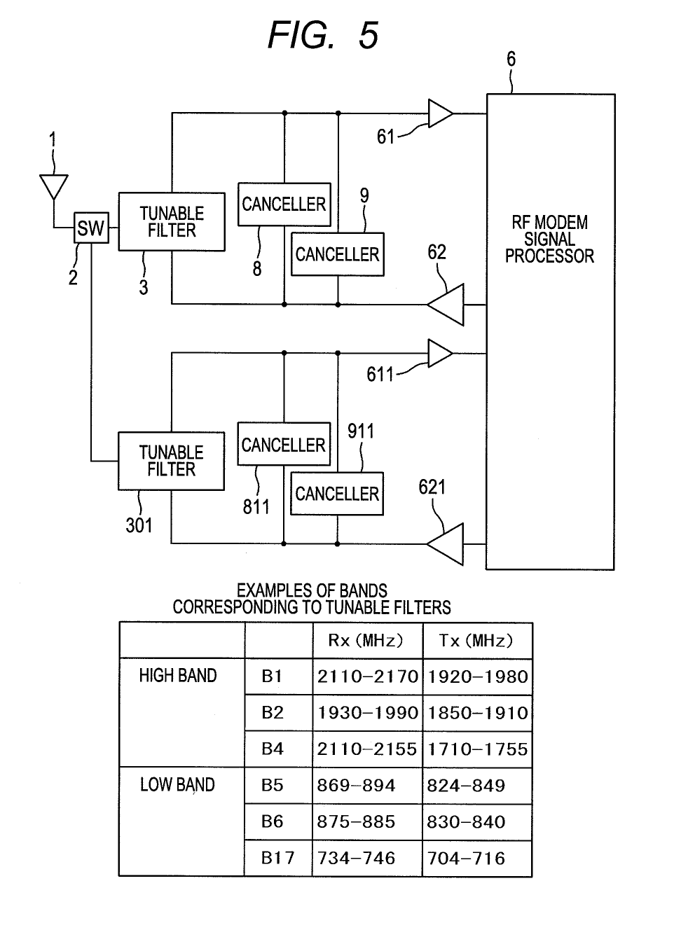

FIG. 5 shows a block diagram of this embodiment which is applied to a mobile communication terminal. When receiving the Band 1, 2, 4, 5, 6, 17 as one example of a multiband, the terminals are structured such that Bands 5, 6, and 17 in a band of 700 to 800 MHz are set as a low band, and such that Bands 1, 2, and 4 in a band of 1700 to 2100 MHz are set as a high band. For example, when the tunable filter 3 corresponds to the High Band, the canceller 8, the canceller 9, the PA62, and the LNA61 also correspond to the High Band. In contrast, when the tunable filter 301 corresponds to the Low Band, the canceller 811, the canceller 911, the PA621, and the LNA611 also correspond to the Low Band. One of the Low Band and the High Band can be selected according to the switching of the antenna SW2.

### Second Embodiment

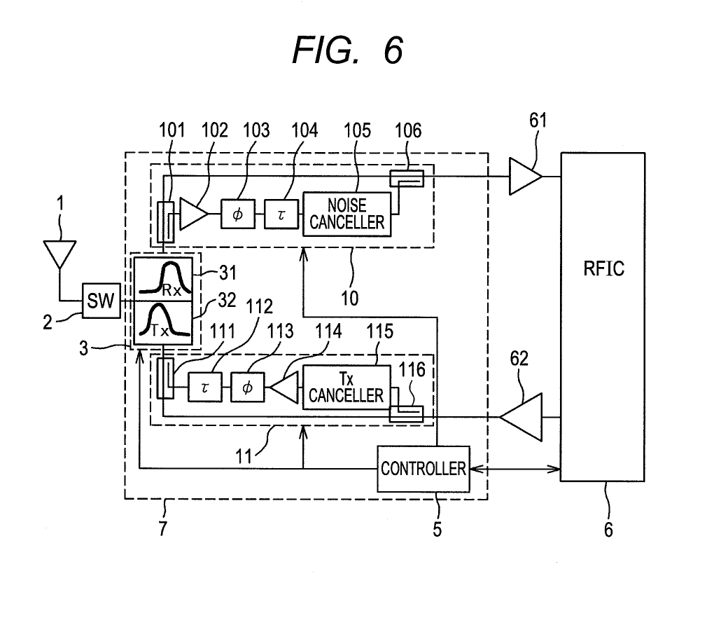

FIG. 6 is a block diagram showing an example of the configuration of a module for a mobile communication terminal according to a second embodiment. The flows of the transmission signal and the reception signal are the same as those of the first embodiment, and thus a description thereof will be omitted below. This embodiment employs a method which involves canceling thermal noise in the reception band at the output of the PA62 on the transmission side, and also canceling a leak component of the transmission signal (LTE signal) on the reception side. On the transmission side, the canceller 11 is disposed, and on the reception side, a canceller 10 is disposed. A canceller 11 is comprised of a coupler 116, a Tx canceller 115, an amplifier 114, a phase shifter 113, a delay unit 112, and a combiner 111. The canceller 10 is comprised of a coupler 101, an amplifier 102, a phase shifter 103, a delay unit 104, a noise canceller 105, and a combiner 106.

The Tx canceller 115 and the noise canceller 105 have the same structures as those of the Tx canceller 97 and the noise canceller 87, respectively.

Now, the flows of signals at the canceller 11 and the canceller 10 will be described below.

The coupler 116 is loosely coupled to the transmission system, and draws the transmission signal attenuated by 10 dB or more and the thermal noise attenuated by 10 dB or more in the reception band, into the canceller 11. The Tx canceller 115 cancels the transmission signal by about 30 dB. The amplifier 114 compensates for the amplitude, the phase shifter 113 compensates for the phase, and the delay unit 112 compensates for the delay. In the combiner 111, the thermal noise in the reception band drawn into the canceller 11 and subjected to the above process is attenuated by 10 dB or more because of the loose coupling, so that the transmission signal from the transmission side and the thermal noise in the reception band are combined. Then, the transmission signal passes therethrough without being cancelled, and the thermal noise in the reception band is cancelled by 20 dB or more.

On the other hand, the coupler 101 is loosely coupled to the reception system, and draws the leak component from the tunable filter 3 attenuated by 10 dB or more into the canceller 10. The amplifier 102 compensates for the amplitude, the phase shifter 103 compensates for the phase, and the delay unit 104 compensates for the delay. In the noise canceller 105, the thermal noise in the reception band is canceled by about 30 dB, so that the thermal noise and harmonic distortion generated by the amplifier 102 are also attenuated. In the combiner 106, the transmission signal drawn into the canceller 10 and subjected to the above processing is attenuated by 10 dB or more because of the loose coupling, and then combined with a leak component from the tunable filter 3. The thermal noise in the reception band passes therethrough without being cancelled, and the transmission signal is cancelled by 20 dB or more.

Both the coupler 116(101) and the combiner 111(106) are loosely coupled. In order to save power consumption of the amplifier 114 of the canceller 11 and the amplifier 102 of the canceller 10, the combiner 111(106) may be tightly coupled.

This embodiment hardly has the influence on the frequency characteristic of the tunable filter 3. Thus, the canceller 10 and the canceller 11 do not need any filter having the same frequency characteristic as that of the tunable filter 3. Thus, the amplifier 114(102) compensates for the amplitude, the phase shifter 113(103) compensates for the phase, and the delay unit 112(104) compensates for the delay, which can ensure the predetermined amount of cancellation of 20 dB or more.

### Third Embodiment

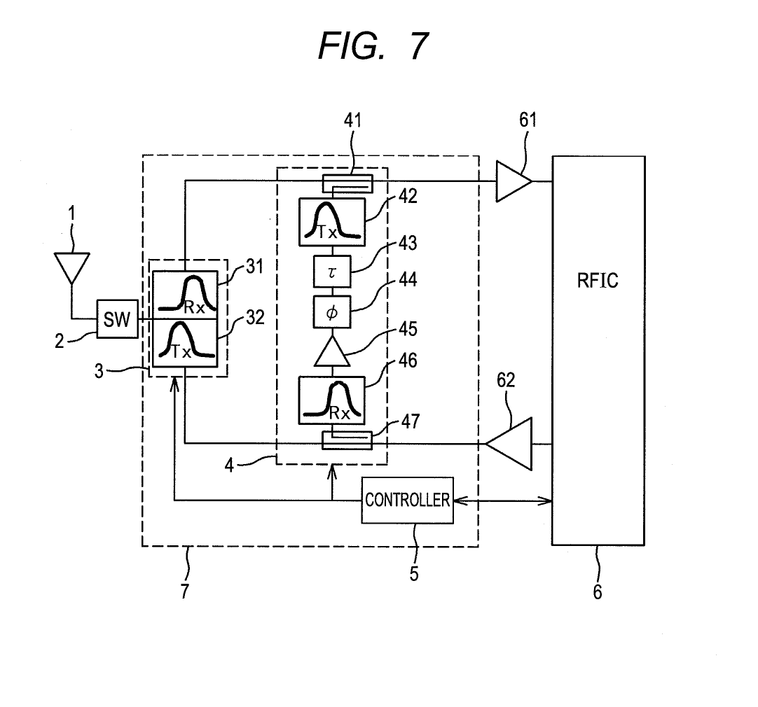

FIG. 7 shows a block diagram of an example of the configuration of a module for a mobile communication terminal according to a third embodiment. The flows of the transmission signal and the reception signal are the same as those of the first embodiment, and thus a description thereof will be omitted below. The first embodiment has two lines of cancellers to thereby individually cancel the leak component of the transmission signal (LTE signal) and the leak component of the thermal noise in the reception band. In contrast, this embodiment has only one line of a canceller 4 to thereby cancel both leak components.

Now, the flow of the signal of the canceller 4 will be described below.

The canceller 4 includes an Rx filter 46 and a Tx filter 42 having the same frequency characteristics as those of the tunable filter 3, unlike a patent document 1. A coupler 47 is loosely coupled to the transmission system, and draws the transmission signal attenuate by 10 dB or more and the thermal noise attenuated by 10 dB or more in the reception band into the canceller 4. The Rx filter 46 attenuates the transmission signal by about 30 dB. An amplifier 45 compensates for the amplitude, a phase shifter 44 compensates for the phase, and a delay unit 43 compensates for the delay. In the Tx filter 42, the thermal noise in the reception band is attenuated by about 30 dB, and the thermal noise and harmonic distortion generated by the amplifier 45 are also attenuated. In the combiner 41, the transmission signal drawn into the canceller 4 and subjected to the above process and the thermal noise in the reception band are loosely coupled to each other to be attenuated by 10 dB or more, and then combined with a leak component from the tunable filter 3. Each of the transmission signal and the thermal noise in the reception band is respectively cancelled by 20 dB or more.

Each of the coupler 47 and the combiner 41 is loosely coupled. In order to save power consumption of the amplifier 45 of the canceller 4, the combiner 41 may be tightly coupled.

In this embodiment, the leak components from the tunable filter 3 are not cancelled individually, which does not need the noise canceller 87(105) and the Tx canceller 97(115). The Rx filter 46 compensates for the frequency characteristic of the tunable filter 3, the amplifier 45 compensates for the amplitude, the phase shifter 44 compensates for the phase, the delay unit 43 compensates for the delay, and the Tx filter 42 compensates for the frequency characteristic of the tunable filter 3. Thus the predetermined amount of cancellation of 20 dB or more can be ensured.

The above-mentioned embodiments are illustrative only, and the present invention is not limited thereto. For example, although both the transmission signal and the thermal noise are cancelled in the respective embodiments, if one of both the signal and the noise has only to be cancelled, a canceller dedicated for one to be cancelled may be provided. Additionally, other embodiments can be proposed by modifying the arrangements of the components shown in the respective circuit block diagrams or the like, and are considered to be within the scope of the invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A module for a mobile communication terminal having different respective frequency bands for a transmission RF signal to be transmitted and a reception RF signal to be received, the module comprising:
an input/output unit for outputting the transmission RF signal to an antenna provided outside the module, and for receiving input of the reception RF signal from the antenna provided outside the module;
a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit;
a first canceller which is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception signal; and
a second canceller which is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal.

2. The module for a mobile communication terminal according to claim 1, wherein each of the first canceller and the second canceller includes a second Tx filter having substantially the same frequency characteristic as that of the Tx filter included in the DPX filter, and a second Rx filter having substantially the same frequency characteristic as that of the Rx filter included in the DPX filter.

3. A module for a mobile communication terminal having different respective frequency bands for a transmission RF signal to be transmitted and a reception RF signal to be received, the module comprising:
an input/output unit for outputting the transmission RF signal to an antenna provided outside the module, and for receiving input of the reception RF signal from the antenna provided outside the module;
a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit; and
a canceller which is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception RF signal, or a canceller which is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal,
wherein the canceller includes a second Tx filter having substantially the same frequency characteristic as that of the Tx filter included in the DPX filter, and a second Rx filter having substantially the same frequency characteristic as that of the Rx filter included in the DPX filter.

4. A module for a mobile communication terminal having different respective frequency bands for a transmission RF signal to be transmitted and a reception RF signal to be received, the module comprising:
an input/output unit for outputting the transmission RF signal to an antenna provided outside the module, and for receiving input of the reception RF signal from the antenna provided outside the module;
a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit; and
at least one of a first canceller and a second canceller, the first canceller being adapted to allow a part of the transmission RF signal to branch on a preceding stage of the Tx filter included in the DPX filter, to apply predetermined signal processing to the branched signal, and then to combine the processed signal with the transmission RF signal to thereby cancel a thermal noise component in the frequency band of the reception RF signal included in the transmission RF signal, and the second canceller being adapted to allow a part of the reception RF signal to branch on a subsequent stage of the Rx filter included in the DPX filter, to apply other predetermined signal processing to the branched signal, and then to combine the processed signal with the reception RF signal to thereby cancel a leak component of the transmission RF signal included in the reception RF signal.

5. The module for a mobile communication terminal according to claim 3,
wherein the canceller includes a combiner for combining the transmission RF signal branched and subjected to the predetermined signal processing with the reception RF signal, and
wherein the combiner includes a matching circuit, and is a differential amplifier having one input terminal to which the branched transmission RF signal subjected to the predetermined signal processing is supplied, and the other input terminal to which the reception RF signal is supplied.

6. The module for a mobile communication terminal according to claim 3, wherein the second Rx filter included in the canceller is located previous to the second Tx filter included in the canceller.

7. The module for a mobile communication terminal according to claim 3, wherein the DPX filter is a tunable filter that varies the frequency bands at which the transmission RF signal and the reception RF signal pass through the frequency bands.

8. A mobile communication terminal having different respective frequency bands for a transmission RF signal to be transmitted and a reception RF signal to be received, wherein a module for the mobile communication terminal included in the mobile communication terminal, for transmitting the transmission RF signal and for receiving the reception RF signal, includes:
an input/output unit for outputting the transmission RF signal to an antenna provided outside the module, and for receiving input of the reception RF signal from the antenna provided outside the module;
a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit;
a first canceller which is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception signal; and
a second canceller which is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal.

9. A mobile communication terminal having different respective frequency bands for a transmission RF signal to be transmitted and a reception RF signal to be received, wherein a module for the mobile communication terminal included in the mobile communication terminal, for transmitting the transmission RF signal and for receiving the reception RF signal, includes:
an input/output unit for outputting the transmission RF signal to an antenna provided outside the module, and for receiving input of the reception RF signal from the antenna provided outside the module;
a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit; and
a canceller which is adapted to allow a part of the transmission RF signal to branch from a preceding stage of the Tx filter included in the DPX filter, to apply predetermined signal processing to the branched signal, and then to combine the processed signal with the reception RF signal on a subsequent stage of the Rx filter included in the DPX filter to thereby cancel a leak component of the transmission RF signal included in the reception RF signal, or a canceller which is adapted to allow another part of the transmission RF signal to branch from a preceding stage of the Tx filter included in the DPX filter, to apply other predetermined signal processing to the branched signal, and then to combine the processed signal with the reception RF signal on a subsequent stage of the Rx filter included in the DPX filter to thereby cancel a thermal noise component in the frequency band of the reception RF signal included in the reception RF signal,
wherein the canceller includes a second Tx filter having substantially the same frequency characteristic as that of the Tx filter included in the DPX filter, and a second Rx filter having substantially the same frequency characteristic as that of the Rx filter included in the DPX filter.

10. A mobile communication terminal having different respective frequency bands for a transmission RF signal to be transmitted and a reception RF signal to be received, wherein a module for the mobile communication terminal included in the mobile communication terminal, for transmitting the transmission RF signal and for receiving the reception RF signal, includes:
an input/output unit for outputting the transmission RF signal to an antenna provided outside the module, and for receiving input of the reception RF signal from the antenna provided outside the module;
a DPX filter including a Tx filter to which the transmission RF signal is supplied from an external transmission RF circuit and which allows a signal in the frequency band of the transmission RF signal to pass therethrough to thereby supply the signal to the input/output unit, and an Rx filter to which the reception RF signal is supplied from the input/output unit, and which allows a signal in the frequency band of the reception RF signal to pass therethrough to thereby supply the signal to an external reception RF circuit; and
at least one of a first canceller and a second canceller, the first canceller being adapted to allow a part of the transmission RF signal to branch on a preceding stage of the Tx filter included in the DPX filter, to apply predetermined signal processing to the branched signal, and then to combine the processed signal with the transmission RF signal to thereby cancel a thermal noise component in the frequency band of the reception RF signal included in the transmission RF signal, and the second canceller being adapted to allow a part of the reception RF signal to branch on a subsequent stage of the Rx filter included in the DPX filter, to apply other predetermined signal processing to the branched signal, and then to combine the processed signal with the reception RF signal to thereby cancel a leak component of the transmission RF signal included in the reception RF signal.
